(19) United States
(12) Patent Application Publication
(10) Pub. No.: US 2021/0046573 A1
(43) Pub. Date: Feb. 18, 2021

(54) ONE-SIDE SUBMERGED ARC WELDING METHOD AND ONE-SIDE SUBMERGED ARC WELDING DEVICE

(71) Applicant: Kabushiki Kaisha Kobe Seiko Sho (Kobe Steel, Ltd.), Kobe-shi (JP)

(72) Inventors: Hiroyoshi YOKOTA, Kanagawa (JP); Masaharu KOMURA, Kanagawa (JP); Daisuki SUGIYAMA, Kanagawa (JP); Koji SATO, Kanagawa (JP)

(73) Assignee: Kabushiki Kaisha Kobe Seiko Sho (Kobe Steel, Ltd.), Kobe-shi (JP)

(21) Appl. No.: 16/966,231

(22) PCT Filed: Jan. 25, 2019
(86) PCT No.: PCT/JP2019/002581

§ 371 Date: Jul. 30, 2020

(30) Foreign Application Priority Data
Jan. 31, 2018 (JP) 2018-015843

(51) Int. Cl. B23K 9/18; B23K 9/12; B23K 9/095

(52) U.S. Cl. CPC B23K 9/18; B23K 2103/04; B23K 9/0953; B23K 9/126

(57) ABSTRACT

A one-side submerged arc welding method includes setting: a welding speed transition section, in which welding is performed such that a welding speed is lowered from a welding speed of main welding to a welding speed being 80% or less of the welding speed of main welding; and a low welding speed section, in which welding is performed at a welding speed being 80% or less of the welding speed of main welding. A length of the welding speed transition section is set to be more than 200 mm and 1,000 mm or less. The low welding speed section is set as a section from a position of 100 mm or more and less than 1,000 mm in front of the end part of the steel plates to the end part.

### TECHNICAL FIELD

The present invention relates to a one-side submerged arc welding method and one-side submerged arc welding device.

### BACKGROUND ART

The one-side submerged arc welding is a high-efficiency welding execution method applied as plate joint welding to a variety of fields, mainly shipbuilding. In butt welding employing a one-side submerged arc welding method, basically welding is performed under the same welding execution conditions from its start to end. Although the welding conditions may be changed depending on the gap, occurrence of a failure relating to groove accuracy, or the like, this is an adjustment mainly intended to improve a bead shape which is one of welding quality items and the welding conditions are not drastically changed.

The one-side submerged arc welding has a problem that cracking (longitudinal cracking) of weld metal is likely to occur at an end part of a weld joint. In particular, the probability of occurrence of cracking (commonly called cracking at end part) at an end part of a weld joint is very high, and various countermeasures therefor have been proposed. For example, Patent Literature 1 discloses a submerged arc welding method in which welding from a position of 1,000 mm or more in front of an end part of steel plates to the end part is performed at a welding speed of 70% or less of a main welding speed.

### CITATION LIST

### Patent Literature

Patent Literature 1: Japanese Patent No. 6184362

### SUMMARY OF INVENTION

### Technical Problem

In recent years, from the viewpoint of increasing the efficiency of welding work, the submerged arc welding has been required to be shortened in welding time. hi the welding method disclosed in Patent Literature 1, welding time becomes long because the welding speed is lowered from a position of 1,000 mm or more in front of the end part. It is therefore required to shorten the welding working time further.

The present invention has been made in view of the above-described problem, and an object of the invention is to provide a one-side submerged arc welding method and a one-side submerged arc welding device capable of preventing cracking of weld metal at an end part portion, performing welding with high efficiency, and making it unnecessary to make manual correction after welding.

### Solution to Problem

The present invention is a one-side submerged arc welding method for welding two steel plates butted against each other from one surface side of the steel plates, the method including setting in an end part side of the steel plates: a welding speed transition section, in which welding is performed such that a welding speed is lowered from a welding speed of main welding to a welding speed being 80% or less of the welding speed of main welding; and a low welding speed section from an end of the welding speed transition section to an end part of the steel plates, in which welding is performed at a welding speed being 80% or less of the welding speed of main welding, in which a length of the welding speed transition section is set to be more than 200 mm and 1,000 mm or less, in which the low welding speed section is set as a section from a position of 100 mm or more and less than 1,000 mm in front of the end part of the steel plates to the end part.

In one embodiment of the one-side submerged arc welding method of the present invention, the welding speed is lowered gradually in the welding speed transition section.

In one embodiment of the one-side submerged arc welding method of the present invention, the welding is performed so as to satisfy the following relationship: Q′/Q=0.60 to 1.30, in which Q is a total heat input (kJ/mm) in the main welding and Q′ is a total heat input (kJ/mm) in welding in the low welding speed section.

In one embodiment of the one-side submerged arc welding method of the present invention, the welding is performed using two to four electrodes.

The present invention is a one-side submerged arc welding device for welding two steel plates butted against each other from one surface side of the steel plates, the device including a control unit to which welding conditions of the welding are input and which is configured to control the welding based on the welding conditions, in which the control unit is configured to set in an end part side of the steel plates: a welding speed transition section, in which welding is performed such that a welding speed is lowered from a welding speed of main welding to a welding speed being 80% or less of the welding speed of main welding;

and a low welding speed section from an end of the welding speed transition section to an end part of the steel plates, in which welding is performed at a welding speed being 80% or less of the welding speed of main welding, in which the device is configured to conduct submerged arc welding in which a length of the welding speed transition section is set to be more than 200 mm and 1,000 mm or less, and the low welding speed section is set as a section from a position of 100 mm or more and less than 1,000 mm in front of the end part of the steel plates to the end part.

One embodiment of the one-side submerged arc welding device of the present invention includes an end part position detecting unit configured to detect an end part position of the steel plates.

### Advantageous Effects of Invention

The invention can provide a one-side submerged arc welding method and a one-side submerged arc welding device capable of preventing cracking of weld metal at an end part portion, performing welding with high efficiency, and making it unnecessary to make manual correction after welding.

### BRIEF DESCRIPTION OF DRAWINGS

FIG. 1 is a schematic explanatory diagram of a welding device according to an embodiment of the present invention.

FIG. 2 is a schematic explanatory diagram of a one-side submerged arc welding method according to the embodiment of the invention.

FIG. 3 is a schematic explanatory diagram of a one-side submerged arc welding method according to the embodiment of the invention.

FIG. 4 is a schematic explanatory diagram of a one-side submerged arc welding method according to the embodiment of the invention.

### DESCRIPTION OF EMBODIMENTS

An embodiment of the present invention will be hereinafter described in detail.

A one-side submerged arc welding method according to the embodiment of the invention is a welding method for welding two steel plates butted against each other from one surface side of the steel plates. This welding method includes setting a welding speed transition section, in which welding is performed such that a welding speed is lowered from a welding speed of main welding to a welding speed being 80% or less of the welding speed of main welding, and a low welding speed section from an end of the welding speed transition section to an end part of the steel plates, in which welding is performed at a welding speed (hereinafter referred to as a “reduced welding speed” when appropriate) being 80% or less of the main welding speed. The length of the welding speed transition section is set to be more than 200 mm and 1,000 mm or less and the low welding speed section is set as a section from a position of 100 mm or more and less than 1,000 mm in front of the end part of the steel plates to the end part.

The present inventors have found that if the welding speed is lowered quickly from a position of less than 1,000 mm in front of the end part, a convex bead may be formed at the position where the welding speed starts to be lowered. In the submerged arc welding method according to the embodiment, the welding speed transition section is set to prevent the occurrence of such a convex bead. The setting of the welding speed transition section is considered to also influence improvement in cracking at end part.

From the viewpoint of prevention of cracking at end part, the low welding speed section starts from a position of 100 mm or more in front of the end part. From the viewpoint of increasing the welding efficiency, the low welding speed section starts from a position of less than 1,000 mm in front of the end part. It is preferable that the low welding speed section start from a position of 700 mm or less in front of the end part, even preferably from a position of 400 mm or less in front of the end part. It is preferable that the low welding speed section start from a position of 200 mm or more in front of the end part.

If the length of the welding speed transition section is 200 mm or less, the effect of preventing occurrence of convex beads cannot be obtained. If the length of the welding speed transition section is more than 1,000 mm, the welding efficiency is low. Thus, the length of the welding speed transition section is set to be more than 200 mm and 1,000 mm or less. It is preferable that the length of the welding speed transition section be 250 mm or more. It is preferable that the length of the welding speed transition section be 700 mm or less, even preferably 400 mm or less.

### (Welding Speed Transition Section)

The welding speed transition section in the embodiment will now be described with reference to FIG. 2. The welding speed transition section is a region where the welding conditions make transition. Section a shown in FIG. 2 is the main welding speed section in which welding is performed at a main welding speed. Section b is the low welding speed section in which welding is performed under preset end-part-side low-speed welding conditions. In the embodiment, the welding speed in section b is a low, constant speed being 80% or less of the main welding speed.

Section c between section a and section b is the welding speed transition section c in which the welding speed is lowered to make a transition from the main welding speed to the speed of the above-mentioned low-speed welding conditions in section b. From the viewpoint of welding efficiency, it is preferable that section b and section c be less than 1,000 mm in total, even preferably be 800 mm or less.

Next, an outline of a main part of a one-side submerged arc welding device and steel plates used in the melding method according to the embodiment of the invention will be described.

### (Welding Device)

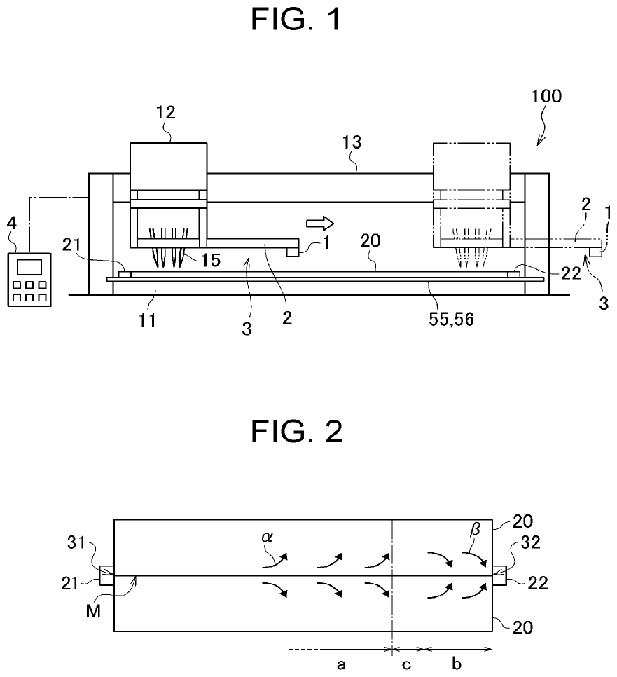

As shown in FIG. 1, a welding device 100 is mainly equipped with a stage frame 11, a welder 12 (welding cart), and a welder beam 13.

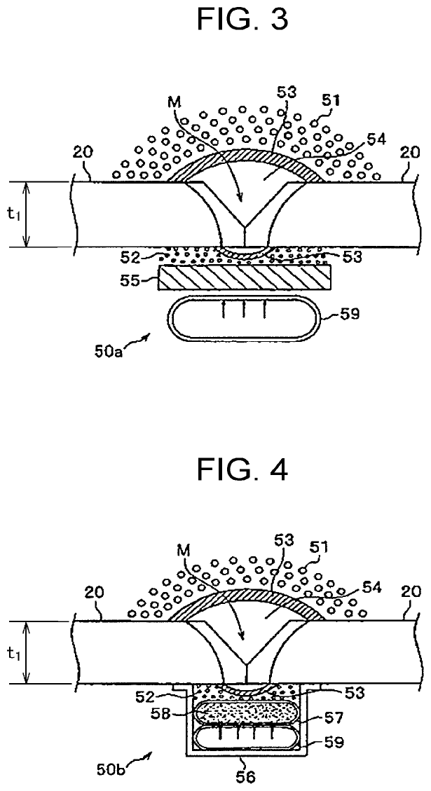

The stage frame 11 is a framework of rectangular steel blocks formed to have a recessed shape in cross section and to be open at the top. A backing device 50a shown in FIG. 3 or a backing device 50b shown in FIG. 4 is supported inside the stage frame 11. Steel plates 20 are mounted on a backing copper plate 55 of the backing device 50a or a refractory canvas 56 of the backing device 50b.

The welder beam 13 is configured to move the welder 12 in the longitudinal direction of the steel plates 20.

The welding device 100 according to the embodiment is equipped with a control unit 4 configured to control the welding conditions. The control unit 4 can perform controls so that submerged arc welding is performed in such a manner that the length of the welding speed transition section is set to be more than 200 mm and 1,000 mm or less and the low welding speed section is set to be a section from a position of 100 mm or more and less than 1,000 mm in front of the end part of the steel plates to the end part.

The welder 12 is installed above the stage frame 11 (above the steel plates 20) and serves to weld the steel plates 20 to each other from the front side of a welding groove M (see FIG. 2) of the steel plates 20. In this example, the welder 12 is equipped with four electrodes (welding torches) 15. The welder 12 welds the steel plates 20 to each other from the front side of the welding groove M by one-side submerged arc welding by means of the electrodes 15 while moving at a predetermined speed along the welder beam 13. Although in this example the four electrodes 15 are employed, the number of electrodes 15 may be two or more. From the viewpoint of applying for welding of thick steel plates and making it easier to satisfy both of high efficiency and high imaging quality, it is preferable that the number of electrodes 15 be two to four. The welder 12 (welding cart) in the embodiment is equipped with an end part position detecting unit 3.

The end part position detecting unit 3 is equipped with an arm 2 extending in the welding direction from the stage frame 11 of the welder 12 and a sensor 1 provided on the arm 2 on its tip side. In the embodiment, the length of the arm 2 is, for example, 1,000 mm or less. In this case, welding can be performed without requiring an excessive space during the welding. The sensor 1 is, for example, a magnetic sensor that can detect presence of the steel plates 20 which are members to be welded and hence recognize an end part position of the steel plates 20. More specifically, after a start of welding, when the steel plates 20 come to be absent under the sensor 1, the sensor 1 sends end part position information to the control unit 4 controlling the welding. The sensor 1 is not limited to a magnetic sensor and can be any of typical sensors such as a contact sensor. Since steel plates having various sizes are welded together in an actual operation, the presence of the end part position detecting unit 3 makes the welding device easy to use.

As shown in FIG. 3 and FIG. 4, the one-side submerged arc welding method is a welding method in which backing flux 52 that has been scattered on the backing copper plate 55 in layer or backing flux 52 housed in the refractory canvas 56 is pressed from the side of the back surfaces of the steel plates 20, 20 butted against each other by a push-up mechanism such as an air hose 59, In the multiple-electrode one-side submerged arc welding method, submerged arc welding is performed from the front side of the steel plates 20 using front flux 51, thereby forming beads on the front surfaces and the back surfaces of the steel plates 20 simultaneously. In FIG. 3 and FIG. 4, symbol 53 denotes slag, symbol 54 denotes weld metal, symbol 57 denotes a flux bag, and symbol 58 denotes underlay flux.

Examples of the steel plates 20 include steel plates for shipbuilding, and the length thereof is 10 to 30 m, for example. As shown in FIG. 2, the steel plates 20 butted against each other and subjected to discontinuous or continuous in-plane tack welding at the position of the welding groove M. The term “discontinuous in-plane tack welding” means that in-plane tack welding has been made at several positions along the joining line (welding line) of the steel plates 20 rather than along the entire joining line (welding line). The number of welding portions may be set such that no particular problems occur during welding. The term “continuous in-plane tack welding” means that in-plane tack welding has been made along the entire joining line (welding line). A bead formed by the continuous in-plane tack welding is equivalent to a single-layer sealing bead and is different from a sealing cascade bead consisting of two or more layers. The term “sealing cascade bead” used herein is a bead consisting of two or more layers (multiple layers) and step-shaped. The in-plane tack welding may be performed by a common tack welding method.

Tabs 21 and 22 for disposing of craters are attached to the steel plates 20 at a start end 31 and an end part 32, respectively. The tabs 21 and 22 employed in the embodiment are not formed with a slit or the like. A tab plate may be provided or may not be provided. For example, a tab plate having a length of 300 mm in the welding direction may be used.

The steel plates 20 are welded to each other from their start end 31 to their end part 32. During welding at a high main welding speed, opening deformation α occurs which is rotational deformation from the inside of the steel plates 20 to their outside. The term “main welding” as used herein means welding performed on the steel plates 20 having been subjected to tack welding. The term “main welding speed” means a speed of common, ordinary submerged arc welding, that is, a welding speed of a case where no reduced welding speed is set at an end part of a weld joint (or a joint start end portion), unlike the invention. The main welding speed is 400 to 1,500 mm/min, for example.

In the embodiment, the end part 32 of the steel plates 20 means an exact end part portion on the side where the welding ends, that is, a portion where the steel plates 20 are connected to the tab 22.

The term “end part of a weld joint,” which is a portion commonly recognized in submerged arc welding, means the end part 32 and its neighborhood. In the case where the length of the steel plates 20 is, for example, 10 to 30 m, the end part of the weld joint may be a portion in a range from a position 1,000 mm in front of the end part of the steel plates 20 to the end part 32, for example.

### (Speed Ratio After Lowering of Welding Speed: 80% or Less of Main Welding Speed)

In the case where the speed ratio after reduction of the welding speed in a predetermined region located on the side of the end part 32 is set at 80% or less of the main welding speed, as shown in FIG. 2, contractive deformation β occurs in the predetermined region located on the side of the end part 32 and angular deformation in the end part of the weld joint becomes small, so that the occurrence of cracking at end part is prevented. From the viewpoint of making contractive deformation more likely to occur in the predetermined region located on the side of the end part 32, the speed ratio after deceleration is preferably 70% or less, even preferably 60% or less, and further preferably 40%. The welding efficiency is not significantly lowered as long as the speed ratio after deceleration is 40% or more of the main welding speed. Furthermore, if the speed ratio after deceleration is 40% or more of the main welding speed, a current value for ensuring sound weld metal is large and hence it is not difficult to maintain an arc and a better bead appearance is obtained.

More specifically, the main welding speed is preferably 400 to 1,500 mm/min. In the case where the main welding speed is 400 to 1,500 mm/min, high welding quality can be secured stably in a plate thickness range of 8 to 40 mm. Thus, the main welding speed is preferably set to be 400 to 1,500 mm/min. The main welding speed is preferably 600 mm/min or more, even preferably 800 mm/min or more.

The reduced welding speed is preferably 200 mm/min or more. In the case where the reduced welding speed is 200 mm/min or more, the welding efficiency is not significantly lowered. In the case where the reduced welding speed is 200 mm/min or more, a current value for ensuring sound weld metal is large and hence it is not difficult to maintain an arc and a better bead appearance is obtained. Furthermore, in the case where the reduced welding speed is 200 mm/min or more and a current value capable of maintaining an arc is employed, high welding quality can be ensured for a front bead and a back bead. Thus, the reduced welding speed is preferably set to be 200 mm/min or more. It is preferable that the welding speed be lowered gradually in the welding speed transition section.

### (Welding Heat Input)

It is preferable that the steel plates 20 be welded to each other so as to satisfy a relationship Q′/Q=0.60 to 1.30, where Q is the total heat input (kJ/mm) in the main welding and Q′ is the total heat input (kJ/mm) in welding in the low welding speed section. In the case where Q′/Q is 1.30 or less, cracking at end part can be prevented by causing contractive deformation β and sound weld metal can be obtained by preventing excessive reinforcement of weld. In the case where the total heat input Q′ in the welding in the low welding speed section is equal to or more than 0.60 times the total heat input Q in the main welding, an arc can be maintained satisfactorily and hence sound weld metal can be obtained.

From the viewpoint of making it easier to obtain sound weld metal, the value of Q′/Q is preferably 0.70 or more, even preferably 0.80 or more. From the viewpoint of making contractive deformation β more likely to occur in a predetermined region located on the side of the end part 32 and making it easier to obtain sound weld metal, the value of Q′/Q is preferably 1.20 or less.

The total heat input Q can be calculated by the following calculation formula.

$$Q = {\sum }_{i = 1}^{n} \frac{{E}_{i} \times {I}_{i}}{{v}_{i}} \times 0.06 \qquad [ Formula 1 ]$$

In the above formula, Q is the total heat input (kJ/mm), Eᵢ is the voltage (V), Ii is the current (A), vi is the welding speed (mm/min), and i=1, 2, 3, . . . , n where i represents each electrode.

Q′ can be calculated by a formula similar to the above. The term “total heat input” used herein means the sum of heat inputs into the respective electrodes 15. Either a value calculated by the above calculation formula or a value (measurement value) actually measured may be used as the total heat input.

The total heat input in the welding performed at a reduced welding speed can be adjusted by changing one or more of the current, the voltage, and the welding speed. That is, the total heat input may be adjusted using one of the current supplied to each electrode 15, the voltage supplied to each electrode 15, and the welding speed. Alternatively, the total heat input may be adjusted using two or three of them simultaneously.

The total heat input in the welding performed at a reduced welding speed can be adjusted by decreasing the number of electrodes to operate.

In the case where the number of electrodes is decreased, the total heat input in welding performed at a reduced welding speed can be adjusted by, for example, decreasing the number of electrodes to operate to one to three in the case where two to four electrodes 15 are used in the main welding. That is, an adjustment is made by setting the number of electrodes to operate in the welding performed at a reduced welding speed smaller than the number of electrodes to operate in the main welding. The term “electrodes to operate” means electrodes for generating an arc by supplying a current to each of them. The adjustment made in this manner makes it easier to control the current supplied to each electrode 15, thereby further increasing the welding efficiency.

In the welding method according to the invention, it is preferable to perform welding using two to four of the electrodes 15, that is, two to four electrodes. The use of only one electrode 15 is not suitable for welding of thick steel plates. In the case where five or more electrodes are used, high-efficiency welding is possible but there remains room for further improvement necessary to satisfy both of high efficiency and high welding quality. In the case where two or more of the electrodes 15 are used, the welding method according to the invention can be applied to welding of thick steel plates. On the other hand, in the case where four or less of the electrodes are used, high-efficiency welding is possible and better welding quality can be obtained. As such, the use of two to four electrodes enables application to thick plates and makes it easier to satisfy both of high efficiency and high welding quality. Thus, in the welding method according to the invention, it is preferable to perform welding using two to four electrodes.

In one mode of the embodiment, it is possible to start lowering the welding speed from a position of less than 1,000 mm in front of the end part of the steel plates, for example. In this case, one-side submerged arc welding can be performed by detecting the end part position properly even in the case where the welder is equipped with the end part position detecting unit 3 whose arm 2 is shorter than 1,000 mm. That is, since the length of the arm 2 can be made shorter than 1,000 mm, submerged arc welding can be performed without requiring an excessive welding working space.

### EXAMPLES

Examples of the invention will be described below.

Two steel plates having an end surface formed as a slant surface were opposed to and butted against each other to form a Y-shaped groove. The Y-shaped groove had a groove angle of 50°, a groove depth of 17 mm, and a root gap of 0 mm. The steel plates were 2,000 to 3,000 mm in length and 20 mm in thickness and were ship-class certified steel plates DH36.

The Examples used a welding device having two to four electrodes. Welding conditions are shown in Table 1 to Table 3. Table 1 shows main welding conditions, Table 2 shows welding conditions after the speed was lowered on the side of the end part of the steel plates, and conditions other than the welding conditions shown in the tables are common conditions.

TABLE 1

| | | Main welding conditions | | | | | | | | | |
|---|---|---|---|---|---|---|---|---|---|---|---|
| | Number | Current (A) | | | | Voltage (V) | | | | Welding | Heat |
| | of | 1st | 2nd | 3rd | 4th | 1st | 2nd | 3rd | 4th | speed v1 | input Q |
| No. | electrodes | electrode | electrode | electrode | electrode | electrode | electrode | electrode | electrode | (mm/min) | (kJ/mm) |
| 1 | 2 | 900 | 800 | — | — | 35 | 35 | — | — | 420 | 8.5 |
| 2 | 3 | 1,300 | 1,000 | 900 | — | 34 | 42 | 44 | — | 800 | 9.4 |
| 3 | 4 | 1,500 | 1,400 | 1,000 | 1,100 | 32 | 38 | 42 | 46 | 850 | 13.7 |
| 4 | | 1,500 | 1,400 | 1,000 | 1,100 | 32 | 38 | 42 | 46 | 850 | 13.7 |
| 5 | | 1,500 | 1,400 | 1,000 | 1,100 | 32 | 38 | 42 | 46 | 850 | 13.7 |
| 6 | | 1,500 | 1,400 | 1,000 | 1,100 | 32 | 38 | 42 | 46 | 850 | 13.7 |
| 7 | | 1,500 | 1,400 | 1,000 | 1,100 | 32 | 38 | 42 | 46 | 850 | 13.7 |
| 8 | | 1,500 | 1,400 | 1,000 | 1,100 | 32 | 38 | 42 | 46 | 850 | 13.7 |
| 9 | | 1,500 | 1,400 | 1,000 | 1,100 | 32 | 38 | 42 | 46 | 850 | 13.7 |
| 10 | | 1,500 | 1,400 | 1,000 | 1,100 | 32 | 38 | 42 | 46 | 850 | 13.7 |
| 11 | | 1,500 | 1,400 | 1,000 | 1,100 | 32 | 38 | 42 | 46 | 850 | 13.7 |
| 12 | | 1,500 | 1,400 | 1,000 | 1,100 | 32 | 38 | 42 | 46 | 850 | 13.7 |
| 13 | | 1,500 | 1,400 | 1,000 | 1,100 | 32 | 38 | 42 | 46 | 850 | 13.7 |
| 14 | 4 | 1,500 | 1,400 | 1,000 | 1,100 | 32 | 38 | 42 | 46 | 850 | 13.7 |
| 15 | | 1,500 | 1,400 | 1,000 | 1,100 | 32 | 38 | 42 | 46 | 850 | 13.7 |
| 16 | | 1,500 | 1,400 | 1,000 | 1,100 | 32 | 38 | 42 | 46 | 850 | 13.7 |

TABLE 2

| | Low-speed welding | | | | | | | | | |
|---|---|---|---|---|---|---|---|---|---|---|
| | Current (A) | | | | Voltage (V) | | | | Welding | Heat |
| | 1st | 2nd | 3rd | 4th | 1st | 2nd | 3rd | 4th | speed v2 | input Q′ |
| No. | electrode | electrode | electrode | electrode | electrode | electrode | electrode | electrode | (mm/min) | (kJ/mm) |
| 1 | 700 | 600 | — | — | 31 | 33 | — | — | 294 | 8.5 |
| 2 | 900 | 800 | 700 | — | 32 | 38 | 42 | — | 560 | 9.5 |
| 3 | 1,200 | 1,200 | 800 | 900 | 32 | 36 | 34 | 36 | 595 | 14.2 |
| 4 | 1,200 | 1,200 | 800 | 900 | 32 | 36 | 34 | 36 | 595 | 14.2 |
| 5 | 1,200 | 1,200 | 800 | 900 | 32 | 36 | 34 | 36 | 595 | 14.2 |
| 6 | 1,200 | 1,200 | 800 | 900 | 32 | 36 | 34 | 36 | 595 | 14.2 |
| 7 | 1,200 | 1,200 | 800 | 900 | 32 | 36 | 34 | 36 | 595 | 14.2 |
| 8 | 1,000 | 1,000 | 600 | 700 | 28 | 32 | 30 | 32 | 425 | 14.2 |
| 9 | 1,250 | 1,250 | 850 | 950 | 34 | 38 | 36 | 38 | 680 | 13.8 |
| 10 | 900 | 900 | 500 | 600 | 28 | 32 | 30 | 32 | 595 | 8.9 |
| 11 | 1,400 | 1,300 | 900 | 1,000 | 32 | 36 | 40 | 44 | 595 | 17.3 |
| 12 | 900 | 900 | 500 | 500 | 26 | 30 | 28 | 30 | 595 | 8.0 |
| 13 | 1,500 | 1,400 | 1,000 | 1,100 | 32 | 36 | 40 | 44 | 595 | 18.8 |
| 14 | 1,200 | 1,200 | 800 | 900 | 32 | 36 | 34 | 36 | 595 | 14.2 |
| 15 | 1,200 | 1,200 | 800 | 900 | 32 | 36 | 34 | 36 | 595 | 14.2 |
| 16 | 1,300 | 1,300 | 900 | 1,000 | 36 | 40 | 38 | 40 | 765 | 13.6 |

TABLE 3

| | Welding | Heat input | Welding speed | Low welding | | |
|---|---|---|---|---|---|---|
| | speed change | change | transition section | speed section | | Cracking |
| No. | v2/v1 | Q′/Q | (mm) | (mm) | Bead shape | at end part |
| 1 | 0.7 | 1.00 | 500 | 500 | A | None |
| 2 | 0.7 | 1.01 | 500 | 500 | A | None |
| 3 | 0.7 | 1.04 | 220 | 500 | A | None |
| 4 | 0.7 | 1.04 | 500 | 100 | A | None |
| 5 | 0.7 | 1.04 | 500 | 500 | A | None |
| 6 | 0.7 | 1.04 | 500 | 950 | A | None |
| 7 | 0.7 | 1.04 | 1,000 | 300 | A | None |
| 8 | 0.5 | 1.04 | 500 | 500 | A | None |
| 9 | 0.8 | 1.01 | 500 | 500 | A | None |
| 10 | 0.7 | 0.65 | 500 | 500 | A | None |
| 11 | 0.7 | 1.26 | 500 | 500 | A | None |
| 12 | 0.7 | 0.59 | 500 | 500 | B (weld | None |
| | | | | | reinforcement | |
| | | | | | height: low) | |
| 13 | 0.7 | 1.38 | 500 | 500 | B (weld | None |
| | | | | | reinforcement | |
| | | | | | height: high) | |
| 14 | 0.7 | 1.04 | 100 | 500 | C (convex | None |
| | | | | | bead shape) | |
| 15 | 0.7 | 1.04 | 500 | 50 | None | Present |
| 16 | 0.9 | 0.99 | 500 | 500 | None | Present |

Evaluation methods of the Examples will be described below.

### (Bead Shape)

A bead shape was observed visually, and was judged “A” in the case where it was particularly good, judged “B” in the case where it was good, judged “C” in the case where it was bad, and judged “none” in the case where evaluation could not be made because of occurrence of cracking at end part.

### (Cracking at End Part)

Occurrence/non-occurrence of cracking at end part was observed visually to produce a result “present” or “none.”

As shown in Table 3, No. 1 to No. 13 were good for all the evaluation items. On the other hand, in No. 14, the bead shape was convex and hence was bad because of a short welding speed transition section. Cracking at end part occurred in No. 15 because the low welding speed section was too short. Cracking at end part occurred in No. 16 because the welding speed in the low welding speed section was fast.

Although the invention has been described above in detail by presenting the embodiment and the Examples, the spirit of the invention is not limited to what has been described above and its scope of rights should be construed broadly on the basis of the claims. It goes without saying that the content of the invention can be, for example, modified or changed broadly on the basis of the above disclosure.

The present invention is based on Japanese patent application No. 2018-015843 filed on Jan. 31, 2018, the contents of which are incorporated herein by reference.

### REFERENCE SIGNS LIST

1: Sensor
2: Arm
3: End part position detecting unit
4: Control unit
11: Stage frame
12: Welder
13: Welder beam
15: Electrode
20: Steel plate
21, 22: Tab
31: Start end
32: End part
50a , 50b: Backing device
51: Front flux
52: Backing flux
53: Slag
54: Weld metal
55: Backing copper plate
56: Refractory canvas
57: Flux bag
58: Underlay flux
59: Air hose
100: Welding device
a: Main welding speed section
b: Low welding speed section
c: Welding speed transition section

1. A one-side submerged arc welding method for welding two steel plates butted against each other from one surface side of the steel plates, the method comprising setting in an end part side of the steel plates:
a welding speed transition section, in which welding is performed such that a welding speed is lowered from a welding speed of main welding to a welding speed being 80% or less of the welding speed of main welding; and
a low welding speed section from an end of the welding speed transition section to an end part of the steel plates, in which welding is performed at a welding speed being 80% or less of the welding speed of main welding,
wherein a length of the welding speed transition section is set to be more than 200 mm and 1,000 mm or less,
wherein the low welding speed section is set as a section from a position of 100 mm or more and less than 1,000 mm in front of the end part of the steel plates to the end part.

2. The one-side submerged arc welding method according to claim 1, wherein the welding speed is lowered gradually in the welding speed transition section.

3. The one-side submerged arc welding method according to claim 1, wherein the welding is performed so as to satisfy the following relationship:
Q′/Q=0.60 to 1.30
wherein Q is a total heat input (kJ/mm) in the main welding and Q′ is a total heat input (kJ/mm) in welding in the low welding speed section.

4. The one-side submerged arc welding method according to claim 1, wherein the welding is performed using two to four electrodes.

5. A one-side submerged arc welding device for welding two steel plates butted against each other from one surface side of the steel plates, the device comprising a control unit to which welding conditions of the welding are input and which is configured to control the welding based on the welding conditions,
wherein the control unit is configured to set in an end part side of the steel plates:
a welding speed transition section, in which welding is performed such that a welding speed is lowered from a welding speed of main welding to a welding speed being 80% or less of the welding speed of main welding; and
a low welding speed section from an end of the welding speed transition section to an end part of the steel plates, in which welding is performed at a welding speed being 80% or less of the welding speed of main welding,
wherein the device is configured to conduct submerged arc welding in which a length of the welding speed transition section is set to be more than 200 mm and 1,000 mm or less, and the low welding speed section is set as a section from a position of 100 mm or more and less than 1,000 mm in front of the end part of the steel plates to the end part.

6. The one-side submerged arc welding device according to claim 5, comprising an end part position detecting unit configured to detect an end part position of the steel plates.
